(19) United States
(12) Patent Application Publication
(10) Pub. No.: US 2013/0040226 A1
(43) Pub. Date: Feb. 14, 2013

(54) BRAZING MATERIAL FOR BONDING IN ATMOSPHERE, BONDED ARTICLE, AND CURRENT COLLECTING MATERIAL

(71) Applicants: Yuichiro Yamauchi, Yokohama-shi (JP); Shinji Saito, Yokohama-shi (JP)

(72) Inventors: Yuichiro Yamauchi, Yokohama-shi (JP); Shinji Saito, Yokohama-shi (JP)

(73) Assignee: NHK SPRING CO., LTD., Yokohama-shi, Kanagawa (JP)

(21) Appl. No.: 13/642,770

(22) PCT Filed: Apr. 27, 2011
(86) PCT No.: PCT/JP2011/060251

§ 371 Date: Oct. 22, 2012

(30) Foreign Application Priority Data
May 13, 2010 (JP) 2010-111157

(51) Int. Cl. C22C 5/06; C22C 30/00; B32B 15/01; B32B 18/00; H01M 8/04; H01M 4/86

(52) U.S. Cl. 429/516; 429/522; 428/673; 428/450; 420/501; 420/580

(57) ABSTRACT

A brazing alloy for bonding in air, in which the melting point is reduced so as to perform brazing at a low temperature without using flux even in air, is provided. In addition, a bonded article and a current collecting material, each of which is bonded with the brazing alloy and has preferable gas sealing characteristics and superior bonding strength, are provided. The brazing alloy for bonding in air includes Ag and B as essential components. The amount of Ag is not less than 50 vol. % and less than 92 vol. %, and the amount of B is greater than 8 vol. % and not more than 50% vol. %. The amounts of Ag and B are adjusted so that the total of the amounts of Ag and B is 100% including inevitable impurities.

### TECHNICAL FIELD

The present invention relates to a brazing alloy for bonding in air, a bonded article bonded with the brazing alloy, and a current collecting material. In particular, the present invention relates to an improvement of a technique for reducing the melting point of the brazing alloy for bonding in air.

### BACKGROUND ART

Bonded articles formed of a metal member and a metal member, bonded articles formed of a ceramic member and a ceramic member, and bonded articles formed of a ceramic member and a metal member, are obtained by brazing. Recently, requirements for improving accuracy, reliability, and function, of a product, have been increasing, and bonded articles formed of ceramics and metal are utilized in order to satisfy the requirements. In this regard, bonding methods for obtaining the bonding articles have been actively researched.

As a method for bonding a ceramic member and a metal member, an active metal brazing method is generally used. In this method, an element which is active with respect to the ceramic member, such as Ti, Zr, etc., is added to a brazing alloy, and the brazing alloy is heated in a vacuum, whereby a reacted layer is formed on a surface of the ceramic member. Thus, wettability and adhesiveness of the brazing alloy are improved. For example, when nitride is used for the ceramic member, TiN is generated at a first layer on the ceramic member side of the reacted layer. Similarly, when carbide is used for the ceramic member, TIC is generated, and when oxide is used, TiO is generated.

Since the active metal brazing method must be performed by heating in a vacuum or an inert gas atmosphere, the cost of the equipment is high. Moreover, intake and discharge of air are required, whereby the production cannot be continuously performed. Accordingly, the production cost is high. On the other hand, in the fields of semiconductor and medicine, there are cases of using members that cannot be used in a vacuum or an active atmosphere and members that cannot be maintained at high temperatures. In these cases, the production process has limitations. For these reasons, it is required to develop an air brazing technique, by which the production cost is decreased, and by which a preferable bonded article is obtained by heating at relatively low temperatures even in air.

As an air brazing technique, a flux brazing method, in which the brazing is performed in air, is generally used. In this method, flux is applied on a surface of a base material, and the surface is bonded while the flux makes a reductive atmosphere and cuts off oxygen at the bonded portion, whereby a preferable bonded article is obtained. For example, in a case of using “BAg-8” of a Ag brazing alloy as a brazing alloy, a flux with a lower melting point than 780° C. of the melting point of the “BAg-8” is used so as to melt the flux before the brazing alloy melts. Thus, the bonding surface is activated, and the oxidation of the brazing alloy is prevented, whereby a preferable bonded article is obtained.

In the flux brazing method, the bonding is generally performed by local heating with a torch. Therefore, this method is effective for bonding points or lines, but is not suitable for bonding planes. In a case of bonding a ceramic member and a ceramic member and bonding a ceramic member and a metal member by this method, thermal stress is generated by the local heating, which may break the ceramic member. Accordingly, this method is also not suitable for forming a bonded article that has a ceramic member. Moreover, most fluxes tend to corrode metals by themselves or by residues thereof, and in this case, the residues of the flux must be removed in an additional step after the bonding.

Alternatively, as an air brazing technique which does not need flux, a reactive air brazing method may be used (for example, U.S. Patent Application Publication No. 2003/0132270A1). According to the technique disclosed in U.S. Patent Application Publication No. 2003/0132270A1, a ceramic member and a heat-resistant metal member which forms an aluminum oxide layer in air, are used as base materials. The base materials are bonded in air by the reactive air brazing method using a Ag—Cu brazing alloy in which CuO is added to Ag. In this technique, the primary component of the brazing alloy is a noble metal component such as Ag, whereby flux is not necessary in the brazing, and the above-described problems due to the flux do not occur.

In the technique disclosed in U.S. Patent Application Publication No. 2003/0132270A1, the bonding temperature must be higher than the melting point (approximately 961° C.) of Ag. Therefore, there is a possibility that the metal member of the base material is oxidized heavily. In addition, in the case of bonding a metal member and a ceramic member, greater thermal stress is generated due to the difference of thermal expansion coefficient between them according to increase in the bonding temperature.

In view of this, in order to reduce the bonding temperature in the reactive air brazing method, various alloys have been developed for reducing the melting point of Ag brazing alloys. For example, a Ag—Ge—Si brazing alloy is disclosed in Japanese Unexamined Patent Application Laid-open No. 2008-202097.

However, if the Ag—Ge—Si brazing alloy disclosed in Japanese Unexamined Patent Application Laid-open No. 2008-202097 is heated to a bonding temperature, it is greatly oxidized, whereby a preferable bonded article is difficult to obtain. It is required to provide a bonded article having preferable gas sealing characteristics and superior bonding strength without using flux even in air in consideration of improving the productivity and the quality, but which has been difficult due to the above-described problems.

### Disclosure of the Invention

Accordingly, an object of the present invention is to provide a brazing alloy for bonding in air, in which the melting point is reduced so as to perform brazing at a low temperature without using flux even in air. In addition, another object of the present invention is to provide a bonded article and a current collecting material, each of which is bonded with the brazing alloy and has preferable gas sealing characteristics and superior bonding strength.

The present invention provides a brazing alloy for bonding in air, and the brazing alloy includes Ag (silver) and B (boron) as essential components. The amount of Ag is not less than 50 vol. % and less than 92 vol. %, and the amount of B is greater than 8 vol. % and not more than 50% vol. %. The amounts of Ag and B are adjusted so that the total of the amounts of Ag and B is 100% including inevitable impurities.

The brazing alloy for bonding in air of the present invention includes Ag and B as essential components. The component Ag is a primary component that is not easily oxidized even when melted in air. The component B is a low-melting-point material which is oxidized at not less than approximately 300° C. and which has oxides with a relatively low melting point (approximately 577° C.). In these essential components, the amount of Ag is set to be not less than 50 vol. % and less than 92 vol. %, and the amount of B is set to be greater than 8 vol. % and not more than 50 vol. %, while the amounts of Ag and B are adjusted so that the total thereof is 100% including inevitable impurities. Therefore, in a case of using this brazing alloy for brazing a metal member and a metal member, a ceramic member and a ceramic member, or a metal member and a ceramic member, oxidation of the base material is prevented even when the brazing is performed in air. Accordingly, flux is not necessary. Moreover, in this case, the oxidation of the brazing alloy is also prevented.

Since B of the low-melting-point material is included as an essential component, the melting point of the brazing alloy is reduced. Therefore, the bonding temperature can be set to be not more than the melting point (approximately 961° C.) of Ag. Thus, the bonding temperature is reduced and is lower than that in a case of using a conventional Ag brazing alloy for bonding in air. Therefore, when a metal member is used as a base material, oxidation of the base material is prevented, and deterioration of the metal member is prevented. Moreover, when a metal member and a ceramic member are used as base materials, since the bonding temperature is low, the thermal stress due to the difference of the thermal expansion coefficient between them is decreased.

Accordingly, a bonded article having preferable gas sealing characteristics and superior bonding strength is obtained by the brazing without using flux even in air. Moreover, the brazing can be performed in air, and a vacuum treatment is not necessary, whereby the production cost is decreased.

The brazing alloy for bonding in air of the present invention may include various components. For example, various elements may be added as dispersing agents or active elements to the two essential components so as to obtain a bonded article according to the intended uses.

For example, at least one kind selected from the group consisting of Ge (germanium), Al (aluminum), Si (silicon), V (vanadium), Mo (molybdenum), W (tungsten), Mn (manganese), Ti (titanium), Zr (zirconium), and oxides thereof, may be added. In this case, the total of the amounts of B and the added component is set to be greater than 8 vol. % and not more than 50 vol. %, and the amounts of Ag, B, and the added component are adjusted so that the total thereof is 100% including inevitable impurities. When an oxide is added, the “added component” is all of the elements included therein. Thus, a bonded article with superior gas sealing characteristics is obtained. If Ge is used in a bonded article of, for example, a metal member and a ceramic member, Ge oxides are precipitated on the ceramic member. In this case, since Ge acts as an active metal, the wettability is improved. On the other hand, for example, if Zr is used, ZrO₂ which has lower vapor pressure than that of B₂O₃ is generated, whereby the durability is improved.

Alternatively, at least one kind selected from the group consisting of Si (silicon), Ca (calcium), Ti (titanium), Zr (zirconium), nitrides thereof, carbides thereof, and hydrides thereof, may be added. In this case, the total of the amounts of B and the added component is set to be greater than 8 vol. % and not more than 50 vol. %, and the amounts of Ag, B, and the added component are adjusted so that the total thereof is 100% including inevitable impurities. When a nitride, a carbide, or a hydride is added, the “added component” is all of the elements included therein. Thus, a bonded article with superior gas sealing characteristics is obtained. For example, if Zr is used, ZrO₂ which has lower vapor pressure than that of B₂O₃ is generated, whereby the durability is improved.

The brazing alloy for bonding in air of the present invention has a melting point that is reduced as described above and may have a melting point of, for example, not less than 650° C. and not more than 850° C. in air.

The present invention also provides a bonded article that is obtained by bonding with the brazing alloy of the present invention. That is, the bonded article of the present invention is formed of a set of a metal member and a metal member, a set of a ceramic member and a ceramic member, or a set of a metal member and a ceramic member, which are bonded with the brazing alloy of the present invention, and the bonded article has gas sealing characteristics. The bonded article of the present invention may have various structures. For example, the bonded article may be used for a fuel cell or a solid oxide fuel cell.

The present invention further provides a current collecting material that is formed of a set of a metal member and a metal member, a set of a ceramic member and a ceramic member, or a set of a metal member and a ceramic member, which are bonded with the brazing alloy of the present invention. The current collecting material has electrical conductivity. The current collecting material of the present invention may have various structures. For example, the current collecting material may be used for a fuel cell or a solid oxide fuel cell.

### Effects of the Invention

According to the brazing alloy of the present invention, flux is not necessary in bonding even in air, and oxidation of the brazing alloy is prevented. Since the brazing alloy includes B of the low-melting-point material as an essential component, the melting point thereof is reduced. According to the bonded article and the current collecting material of the present invention, they are obtained by using the brazing alloy of the present invention and thereby have preferable gas sealing characteristics and superior bonding strengths.

### BRIEF DESCRIPTION OF THE DRAWINGS

FIG. 1 is a perspective view that shows an approximate structure of a bonded specimen formed in the Examples of the present invention.

FIG. 2 shows a bonded specimen for cross sectional observation used in the Examples of the present invention and shows a side cross sectional structure taken along a direction indicated by arrows 1A in FIG. 1.

FIG. 3 is an electron micrograph (30-times magnification) of a cross section of a bonded specimen that was obtained by bonding with a brazing alloy relating to the sample 1 of the present invention.

FIG. 4 is an electron micrograph (500-times magnification) of an enlarged cross section of an essential part of the bonded specimen relating to the sample 1 shown in FIG. 3.

FIG. 5 is an electron micrograph (30-times magnification) of a cross section of a bonded specimen that was obtained by bonding with a brazing alloy relating to the sample 2 of the present invention.

FIG. 6 is an electron micrograph (500-times magnification) of an enlarged cross section of an essential part of the bonded specimen relating to the sample 2 shown in FIG. 5.

FIG. 7 is an electron micrograph of a cross section of a bonded specimen that was obtained by bonding with a brazing alloy relating to the sample 3 of the present invention.

FIGS. 8A to 8E show results of element distribution analyses of the bonded specimen relating to the sample 3 shown in FIG. 7. FIG. 8A is a result of a distribution analysis of Ag, FIG. 8B is a result of a distribution analysis of Ge, FIG. 8C is a result of a distribution analysis of B, FIG. 8D is a result of a distribution analysis of Zr, and FIG. 8E is a result of a distribution analysis of 0.

FIGS. 9A to 9C are electron micrographs (500-times magnification) of cross sections of bonded specimens that were obtained by bonding with brazing alloys relating to the samples 4A to 4C of the present invention. FIG. 9A is an electron micrograph of a cross section of the bonded specimen of the sample 4A that was heated at 650° C. for 1 hour in bonding. FIG. 9B is an electron micrograph of a cross section of the bonded specimen of the sample 4B that was heated at 750° C. for 1 hour in bonding. FIG. 9C is an electron micrograph of a cross section of the bonded specimen of the sample 4C that was heated at 850° C. for 1 hour in bonding.

FIG. 10 is an electron micrograph (500-times magnification) of a cross section of a bonded specimen that was obtained by bonding with a brazing alloy relating to the sample 6 of the present invention.

FIG. 11 is an electron micrograph (300-times magnification) of a cross section of a bonded specimen that was obtained by bonding with a brazing alloy relating to the comparative sample 1.

### EXPLANATION OF REFERENCE NUMERALS

10 denotes a bonded specimen, 11 denotes a metal member, 12 denotes a ceramic member, 13 denotes a bonded layer, 14 denotes B particles, 15 denotes melted Ag, 16 denotes unmelted Ag, and 17 denotes a void.

### EXAMPLES

The present invention will be described with reference to examples hereinafter. In the Examples, bonded specimens were formed as samples relating to the present invention by using a brazing alloy for bonding in air, which includes elements at amounts within the scope of the present invention. In addition, other bonded specimens were formed as comparative samples by using a brazing alloy for bonding in air, which includes elements at amounts outside the scope of the present invention. In order to evaluate the bonded specimens of the samples of the present invention and the comparative samples, a leak test was performed on each of the specimens, and bonded portions of some of the specimens were observed.

### (1) Preparation of Samples of the Present Invention and Comparative Samples

Brazing alloys for bonding in air for forming the samples of the present invention included Ag and B as essential components. The amount of Ag was not less than 50 vol. % and less than 92 vol. %, and the amount of B was greater than 8 vol. % and not more than 50% vol. %. The amounts of Ag and B were adjusted so that the total thereof was 100% including inevitable impurities.

Specifically, a brazing alloy including Ag and B as essential components and including at least one kind selected from the group consisting of Ge, Al, Si, V, Mo, W, Mn, Ti, Zr, and oxides thereof, was used. In this case, the total of the amounts of B and the added component was set to be greater than 8 vol. % and not more than 50 vol. %, and the amounts of Ag, B, and the added component were adjusted so that the total thereof was 100% including inevitable impurities. Alternatively, a brazing alloy including Ag and B as essential components and including at least one kind selected from the group consisting of Si, Ca, Ti, Zr, nitrides thereof, carbides thereof, and hydrides thereof, was used. In this case, the total of the amounts of B and the added component was set to be greater than 8 vol. % and not more than 50 vol. %, and the amounts of Ag, B, and the added component were adjusted so that the total thereof was 100% including inevitable impurities.

The brazing alloys for bonding in air for forming the samples of the present invention may be in the form of, for example, a paste in which a metal mixed powder is added to an organic solvent, an organic binder, or the like, an alloy powder paste, a foil, a sol-gel form, or etc. The form of the brazing alloy is not particularly limited.

As the material of the metal member for forming the samples of the present invention, for example, ferrite stainless steel, stainless steel, heat-resistant stainless steel, FeCrAl alloy, FeCrSi alloy, heat-resistant Ni based alloy, etc. may be used. The material of the metal member is not particularly limited. As the material of the ceramic member for forming the samples of the present invention, for example, oxide ceramics such as yttria-stabilized zirconia, zirconia, alumina, magnesia, steatite, mullite, titania, silica, sialon, etc., may be used. The material of the ceramic member is not particularly limited.

In the Examples, a brazing alloy for bonding in air relating to each sample of the present invention was used in a paste form by mixing a metal mixed powder with an organic binder. The metal mixed powder had a composition within the scope of the present invention, as shown in Table 1. As the metal member relating to each sample of the present invention, a cylindrical member made of ZMG232L (manufactured by Hitachi Metals, Ltd.) of a ferrite alloy with an outer diameter of 14 mm and an inner diameter of 8 mm was used. As the ceramic member relating to each sample of the present invention, as shown in Table 1, a stabilized zirconia sheet, a magnesia sheet, an aluminum nitride sheet, an alumina sheet, or a silicon carbide sheet, was used. The size of each sheet was 20 mm×20 mm.

A brazing alloy for bonding in air relating to each comparative sample was used in a paste form by mixing a metal mixed powder with an organic binder. The metal mixed powder had a composition outside the scope of the present invention, as shown in Table 1. The same cylindrical member as for each sample of the present invention was used for the metal member of each comparative sample. As shown in Table 1, a stabilized zirconia sheet was used for the ceramic member. The composition of the brazing alloy for bonding in air was indicated such that the amount (volume ratio) of an element is indicated by a ratio in front of the element in Table 1.

In the Examples, the brazing alloy for bonding in air in the paste form was coated on an end surface of the metal member, and the ceramic member was placed on the coated surface. Then, the metal member and the ceramic member were heated at a bonding condition (temperature and time) shown in Table 1 in air. Thus, bonded specimens relating to the samples of the present invention and the comparative samples were formed.

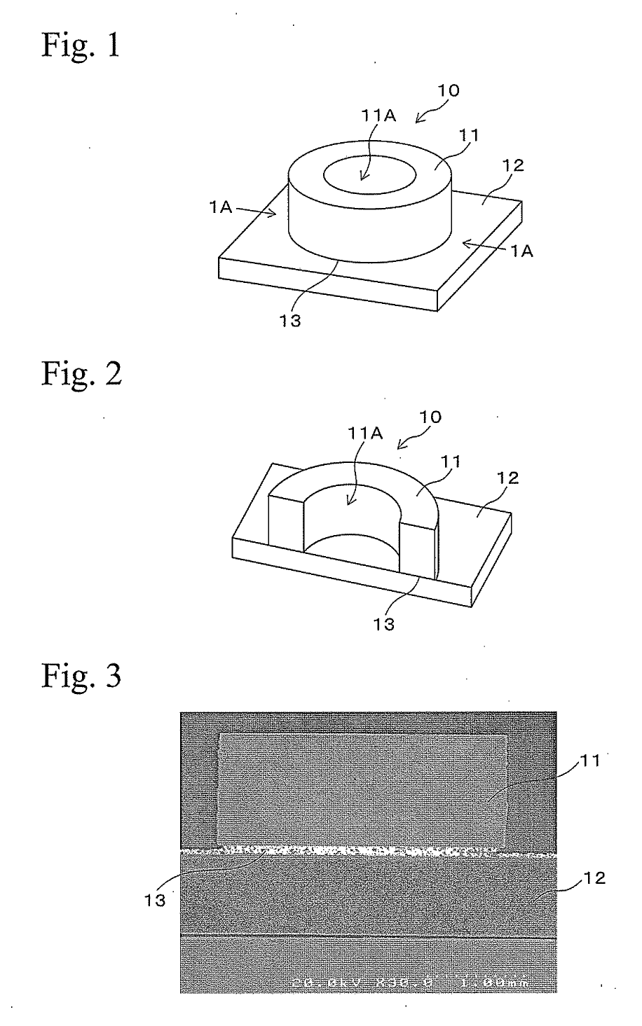

FIG. 1 is a schematic view that shows a structure of a bonded specimen 10. The reference numeral 11 denotes a metal member formed of a cylindrical member, the reference numeral 11A denotes an opening of the metal member, the reference numeral 12 denotes a ceramic member, and the reference numeral 13 denotes a bonded layer. FIG. 2 is a schematic view of a cross section of a bonded portion including the bonded layer 13 for observation (a perspective view that shows a side cross sectional structure taken along a direction indicated by the arrows 1A in FIG. 1).

TABLE 1

| | Composition of brazing | Bonding condition | Material of | Result of helium |
|---|---|---|---|---|
| | alloy (volume %) | Temperature/Time | ceramic member | leak test |
| Sample 1 | Ag—18%B | 750° C./1 hr | Stabilized | No leak |
| | | | zirconia | |
| Sample 2 | Ag—50%B | 750° C./1 hr | Stabilized | No leak |
| | | | zirconia | |
| Sample 3 | Ag—16%Ge—16%B | 850° C./1 hr | Stabilized | No leak |
| | | | zirconia | |
| Sample 4A | Ag—3%Ge—40%B | 650° C./1 hr | Stabilized | No leak |
| | | | zirconia | |
| Sample 4B | Ag—3%Ge—40%B | 750° C./1 hr | Stabilized | No leak |
| | | | zirconia | |
| Sample 4C | Ag—3%Ge—40%B | 850° C./1 hr | Stabilized | No leak |
| | | | zirconia | |
| Sample 5A | Ag—3%Ge—17%B—6%Al | 850° C./1 hr | Stabilized | No leak |
| | | | zirconia | |
| Sample 5B | Ag—3%Ge—17%B—6%Si | 850° C./1 hr | Stabilized | No leak |
| | | | zirconia | |
| Sample 5C | Ag—3%Ge—17%B—6%SiO₂ | 850° C./1 hr | Stabilized | No leak |
| | | | zirconia | |
| Sample 5D | Ag—3%Ge—17%B—3%ZrH₂ | 850° C./1 hr | Stabilized | No leak |
| | | | zirconia | |
| Sample 5E | Ag—3%Ge—17%B—3%V | 850° C./1 hr | Stabilized | No leak |
| | | | zirconia | |
| Sample 5F | Ag—3%Ge—17%B—2%Mo | 850° C./1 hr | Stabilized | No leak |
| | | | zirconia | |
| Sample 5G | Ag—3%Ge—17%B—1%W | 850° C./1 hr | Stabilized | No leak |
| | | | zirconia | |
| Sample 5H | Ag—3%Ge—17%B—3%WO₃ | 850° C./1 hr | Stabilized | No leak |
| | | | zirconia | |
| Sample 5I | Ag—3%Ge—17%B—4%TiH₂ | 850° C./1 hr | Stabilized | No leak |
| | | | zirconia | |
| Sample 5J | Ag—3%Ge—17%B—5%SiC | 850° C./1 hr | Stabilized | No leak |
| | | | zirconia | |
| Sample 6 | Ag—3%Ge—40%B | 850° C./1 hr | Magnesia | No leak |
| Sample 7 | Ag—3%Ge—40%B | 850° C./1 hr | Aluminium | No leak |
| | | | nitride | |
| Sample 8 | Ag—3%Ge—40%B | 850° C./1 hr | Alumina | No leak |
| Sample 9 | Ag—3%Ge—40%B | 850° C./1 hr | Silicon carbide | No leak |
| Comparative | Ag—18%Ge | 850° C./1 hr | Stabilized | Leak |
| sample 1 | | | zirconia | |
| Comparative | Ge—68%B | 850° C./1 hr | Stabilized | Leak |
| sample 2 | | | zirconia | |
| Comparative | Ag—4%Ge—8%B | 850° C./1 hr | Stabilized | Leak |
| sample 3 | | | zirconia | |

### (2) Evaluation of Samples of the Present Invention and Comparative Samples

The bonded specimen 10 was subjected to a helium leak test by sealing the opening HA of the metal member 11 and evacuating the air inside the metal member 11. The results of the helium leak test are shown in Table 1, in which “No leak” indicates that helium was not detected, and “Leak” indicates that helium was detected. In each of the samples 1 to 4 and 6 of the present invention and the comparative sample 1, the bonded specimen 10 was cut at the center portion as shown in FIG. 2, and the bonded portion including the bonded layer 13 was observed. The results of the samples of the present invention and the comparative samples will be described hereinafter.

### (A) Sample 1

As shown in Table 1, the bonded specimen of the sample 1 of the present invention was formed by using a stabilized zirconia sheet as the ceramic member 12 and a brazing alloy with a composition of Ag-18% B by vol. %, and brazing was performed at a heating temperature of 750° C. for 1 hour. In the helium leak test performed on the bonded specimen of the sample 1, the helium did not leak, as shown in Table 1, which indicated that the brazing alloy for bonding in air melted.

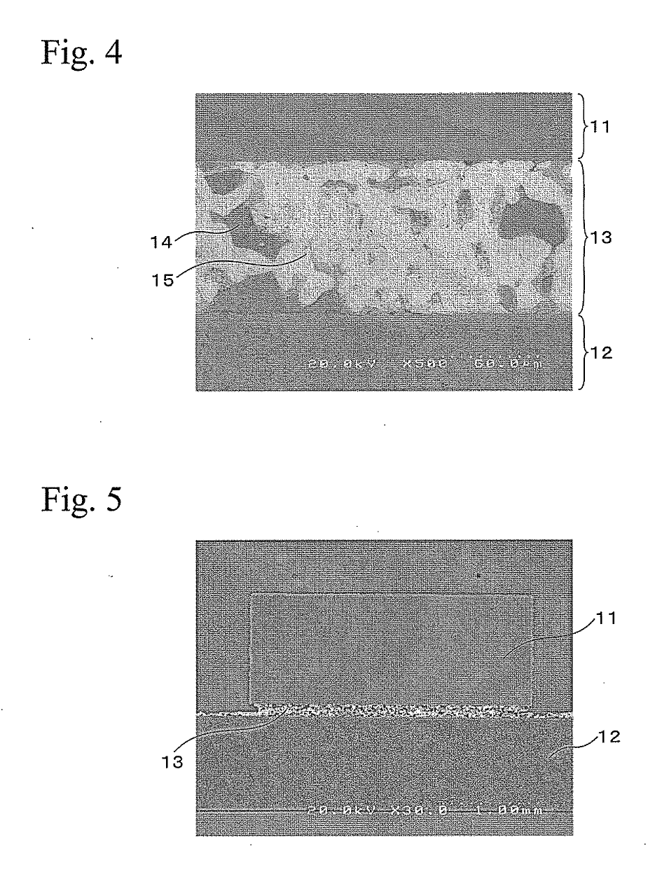

FIG. 3 is an electron micrograph (30-times magnification) of the cross section of the bonded specimen of the sample 1, and FIG. 4 is an electron micrograph (500-times magnification) of an enlarged cross section of an essential part of the bonded specimen of the sample 1 shown in FIG. 3. As shown in FIG. 4, the bonded layer 13 included powder particles of B (hereinafter called “B particles”, reference numeral 14) and Ag that melted (hereinafter called “melted Ag”, reference numeral 15). The bonded layer 13 did not include Ag that did not melt (hereinafter called “unmelted Ag”) and voids. Accordingly, the brazing alloy for bonding in air melted.

### (B) Sample 2

As shown in Table 1, the bonded specimen of the sample 2 of the present invention was formed by using a stabilized zirconia sheet as the ceramic member 12 and a brazing alloy with a composition of Ag-50% B by vol. %, and brazing was performed at a heating temperature of 750° C. for 1 hour. In the helium leak test performed on the bonded specimen of the sample 2, the helium did not leak, as shown in Table 1, which indicated that the brazing alloy for bonding in air melted.

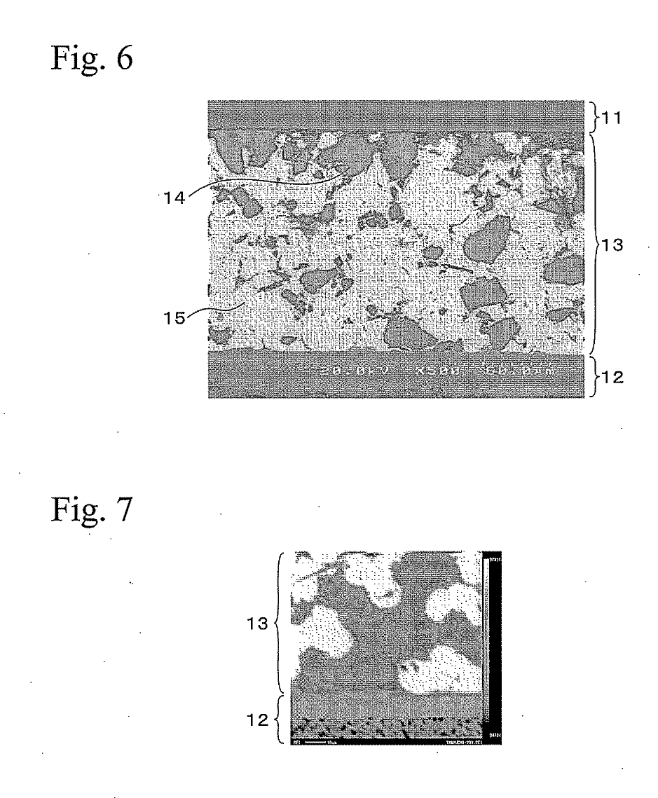

FIG. 5 is an electron micrograph (30-times magnification) of the cross section of the bonded specimen of the sample 1, and FIG. 6 is an electron micrograph (500-times magnification) of an enlarged cross section of an essential part of the bonded specimen of the sample 2 shown in FIG. 5. As shown in FIG. 6, the bonded layer 13 included B particles (reference numeral 14) and melted Ag (reference numeral 15) and did not include unmelted Ag and voids. Accordingly, the brazing alloy for bonding in air melted.

### (C) Sample 3

As shown in Table 1, the bonded specimen of the sample 2 of the present invention was formed by using a stabilized zirconia sheet as the ceramic member 12 and a brazing alloy with a composition of Ag-16% Ge-16% B by vol. %, and brazing was performed at a heating temperature of 850° C. for 1 hour. In the helium leak test performed on the bonded specimen of the sample 2, the helium did not leak, as shown in Table 1, which indicated that the brazing alloy for bonding in air melted.

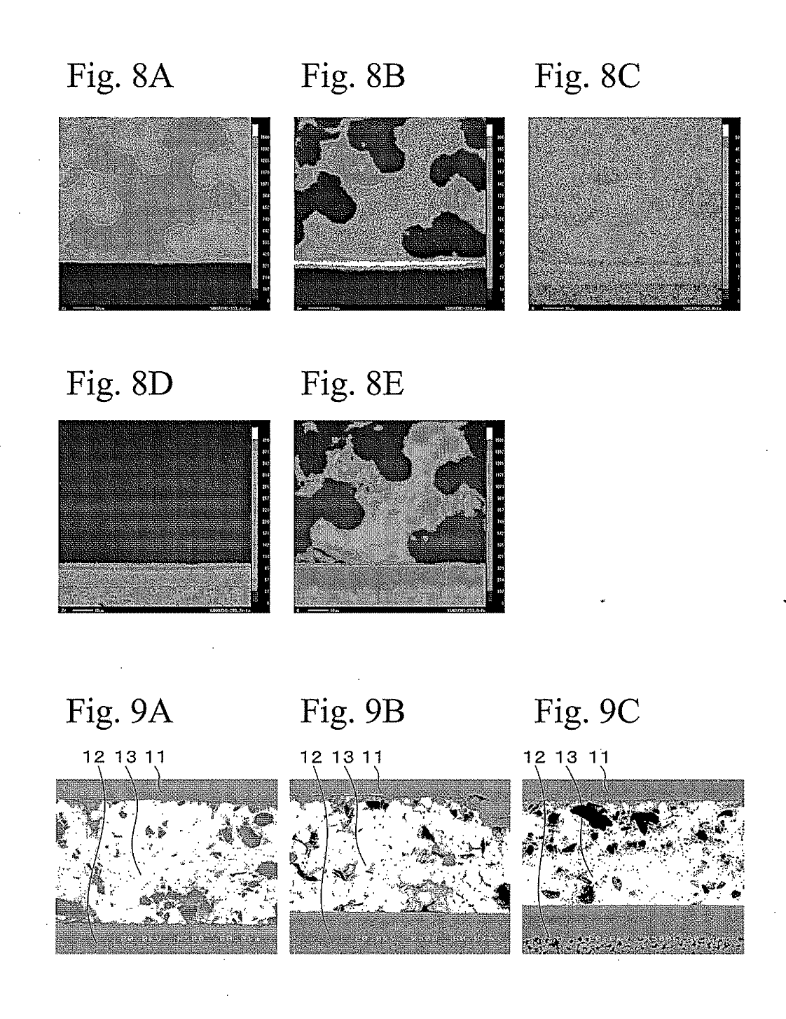

FIG. 7 is an electron micrograph of the cross section of the bonded specimen of the sample 3. FIGS. 8A to 8E show results of element distribution analyses of the bonded specimen shown in FIG. 7. FIG. 8A is a result of a distribution analysis of Ag, FIG. 8B is a result of a distribution analysis of Ge, FIG. 8C is a result of a distribution analysis of B, FIG. 8D is a result of a distribution analysis of Zr, and FIG. 8E is a result of a distribution analysis of O. The area shown in FIG. 7 corresponds to each area shown in FIGS. 8A to 8E. The amount of an element is greater when the color becomes red and is smaller when the color becomes blue in FIGS. 8A to 8E. As shown in FIGS. 8B and 8E, in the bonded specimen of the sample 3, a great amount of oxides of Ge was precipitated. Accordingly, by adding Ge to a brazing alloy for bonding in air, oxides of Ge are precipitated.

### (D) Samples 4A to 4C

As shown in Table 1, the bonded specimens of the samples 4A to 4C of the present invention were formed by using a stabilized zirconia sheet as the ceramic member 12 and a brazing alloy with a composition of Ag-3% Ge-40% B by vol. %. As shown in Table 1, the sample 4A was brazed at a heating temperature of 650° C. for 1 hour, the sample 4B was brazed at a heating temperature of 750° C. for 1 hour, and the sample 4C was brazed at a heating temperature of 850° C. for 1 hour. In the helium leak test performed on each of the bonded specimens of the samples 4A to 4C, the helium did not leak, as shown in Table 1.

FIG. 9A is an electron micrograph (500-times magnification) of the cross section of the bonded specimen of the sample 4A. FIG. 9B is an electron micrograph (500-times magnification) of the cross section of the bonded specimen of the sample 4B. FIG. 9C is an electron micrograph (500-times magnification) of the cross section of the bonded specimen of the sample 4C. As shown in FIGS. 9A to 9C, in each of the bonded specimens of the samples 4A to 4C, the bonded layer 13 did not include unmelted Ag and voids, and the brazing alloy for bonding in air melted. Accordingly, it was confirmed that the brazing alloy for bonding in air having a composition within the scope of the present invention has a melting point of not less than 650° C. and not more than 850° C.

### (E) Samples 5A to 5J

As shown in Table 1, the bonded specimens of the samples 5A to 5J of the present invention were formed by using a stabilized zirconia sheet as the ceramic member 12 and brazing at a heating temperature of 850° C. for 1 hour.

A brazing alloy having a composition of Ag-3% Ge-17% B-6% Al by vol. % was used for the sample 5A. A brazing alloy having a composition of Ag-3% Ge-17% B-6% Si by vol. % was used for the sample 5B. A brazing alloy having a composition of Ag-3% Ge-17% B-6% SiO₂ by vol. % was used for the sample 5C. A brazing alloy having a composition of Ag-3% Ge-17% B-3% Zr11₂ by vol. % was used for the sample 5D.

A brazing alloy having a composition of Ag-3% Ge-17% B-3% V by vol. % was used for the sample 5E. A brazing alloy having a composition of Ag-3% Ge-17% B-2% Mo by vol. % was used for the sample 5F. A brazing alloy having a composition of Ag-3% Ge-17% B-1% W by vol. % was used for the sample 5G. A brazing alloy having a composition of Ag-3% Ge-17% B-3% WO₃ by vol. % was used for the sample 5H. A brazing alloy having a composition of Ag-3% Ge-17% B-4% TiH₂ by vol. % was used for the sample 51. A brazing alloy having a composition of Ag-3% Ge-17% B-5% SiC by vol. % was used for the sample 5J.

In the helium leak test performed on each of the bonded specimens of the samples 5A to 51, the helium did not leak, as shown in Table 1.

### (F) Sample 6

As shown in Table 1, the bonded specimen of the sample 6 of the present invention was formed by using a magnesia sheet as the ceramic member 12 and a brazing alloy with a composition of Ag-3% Ge-40% B by vol. %, and brazing was performed at a heating temperature of 850° C. for 1 hour. In the helium leak test performed on the bonded specimen of the sample 6, the helium did not leak, as shown in Table 1, which indicated that the brazing alloy for bonding in air melted.

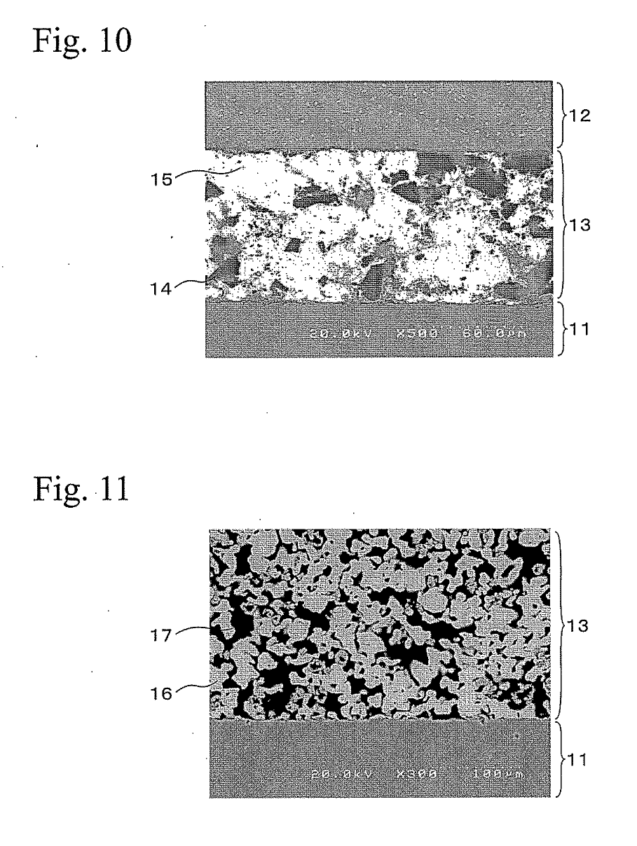

FIG. 10 is an electron micrograph (500-times magnification) of an enlarged cross section of an essential part of the bonded specimen of the sample 1. As shown in FIG. 10, the bonded layer 13 included B particles (reference numeral 14) and melted Ag (reference numeral 15) and did not include unmelted Ag and voids. Accordingly, the brazing alloy for bonding in air melted.

### (F) Sample 7

As shown in Table 1, the bonded specimen of the sample 7 of the present invention was formed by using an aluminum nitride sheet as the ceramic member 12 and a brazing alloy with a composition of Ag-3% Ge-40% B by vol. %, and brazing was performed at a heating temperature of 850° C. for 1 hour. In the helium leak test performed on the bonded specimen of the sample 7, the helium did not leak, as shown in Table 1, which indicated that the brazing alloy for bonding in air melted.

### (F) Sample 8

As shown in Table 8, the bonded specimen of the sample 8 of the present invention was formed by using an alumina sheet as the ceramic member 12 and a brazing alloy with a composition of Ag-3% Ge-40% B by vol. %, and brazing was performed at a heating temperature of 850° C. for 1 hour. In the helium leak test performed on the bonded specimen of the sample 8, the helium did not leak, as shown in Table 1, which indicated that the brazing alloy for bonding in air melted.

### (F) Sample 9

As shown in Table 1, the bonded specimen of the sample 9 of the present invention was formed by using a silicon carbide sheet as the ceramic member 12 and a brazing alloy with a composition of Ag-3% Ge-40% B by vol. %, and brazing was performed at a heating temperature of 850° C. for 1 hour. In the helium leak test performed on the bonded specimen of the sample 9, helium did not leak, as shown in Table 1, which indicated that the brazing alloy for bonding in air melted.

### (G) Comparative Sample 1

As shown in Table 1, the bonded specimen of the comparative sample 1 was formed by using a stabilized zirconia sheet as the ceramic member 12 and a brazing alloy with a composition of Ag-18% Ge by vol. %, and brazing was performed at a heating temperature of 850° C. for 1 hour. In the helium leak test performed on the bonded specimen of the comparative sample 1, the helium leaked, as shown in Table 1, which indicated that the brazing alloy for bonding in air did not melt.

FIG. 11 is an electron micrograph (300-times magnification) of an enlarged cross section of an essential part of the bonded specimen of the comparative sample 1. As shown in FIG. 11, the bonded layer 13 included granular unmelted Ag (reference numeral 16) and voids (reference numeral 17) among the granular unmelted Ag, which indicated that the brazing alloy for bonding in air did not melt. Accordingly, it was confirmed that the Ag—Ge brazing alloy has a melting point of greater than 850° C. and does not have a low melting point.

### (H) Comparative Sample 2

As shown in Table 1, the bonded specimen of the comparative sample 2 was formed by using a stabilized zirconia sheet as the ceramic member 12 and a brazing alloy with a composition of Ge-68% B by vol. %, and brazing was performed at a heating temperature of 850° C. for 1 hour. In the helium leak test performed on the bonded specimen of the comparative sample 2, the helium leaked, as shown in Table 1, which indicated that the brazing alloy for bonding in air did not melt. Accordingly, it was confirmed that the Ge—B brazing alloy has a melting point of greater than 850° C. and does not have a low melting point.

### (I) Comparative Sample 3

As shown in Table 1, the bonded specimen of the comparative sample 3 was formed by using a stabilized zirconia sheet as the ceramic member 12 and a brazing alloy with a composition of Ag-4% Ge-8% B by vol. %, and brazing was performed at a heating temperature of 850° C. for 1 hour. In the helium leak test performed on the bonded specimen of the comparative sample 3, the helium leaked, as shown in Table 1, which indicated that the brazing alloy for bonding in air did not melt. According to the comparison of the comparative sample 3 with the samples 1 to 9, it is preferable that the amount of B is greater than 8%.

According to these results, in order to reduce the melting point of the brazing alloy for bonding in air, B must be added to Ag of the primary component, and the ratios of B and Ag must be set so as to be within the scope of the present invention. Specifically, in the composition of the brazing alloy for bonding in air, the lower limit of the amount of B must be greater than 8 vol. % as described above, and the upper limit of the amount of B must be not more than 50 vol. %. If the upper limit of the amount of B is greater than 50 vol. %, B is included as a primary component, whereby a necessary bonding strength, vapor pressure, and melting point, are not obtained.

By adding other elements to such low-melting point Ag—B brazing alloys for bonding in air, characteristics such as the wettability and the bonding strength can be improved. For example, the results of the sample 3 show that oxides of Ge can be precipitated on the ceramics by adding Ge to the brazing alloy in the bonded article of the metal member and the ceramic member. Moreover, when each metal, oxide, nitride, carbide, or hydride was also added to the two essential components in addition to Ge, each of the bonded articles using such low-melting point Ag—B brazing alloy for bonding in air had superior gas sealing characteristics. Thus, various elements can be added as dispersing agents or active elements to the two essential components, and therefore, there are possibilities of forming bonded articles according to various intended uses.

1. A brazing alloy for bonding in air, including Ag and B as essential components,
wherein the amount of Ag is not less than 50 vol. % and less than 92 vol. %, the amount of B is greater than 8 vol. % and not more than 50% vol. %, and the amounts of Ag and B are adjusted so that the total of the amounts of Ag and B is 100% including inevitable impurities,

2. The brazing alloy for bonding in air according to claim 1, wherein at least one kind selected from the group consisting of Ge, Al, Si, V, Mo, W, Mn, Ti, Zr, and oxides thereof, is further added, the total of the amounts of B and the added component is set to be greater than 8 vol. % and not more than 50 vol. %, and the amounts of Ag, B, and the added component are adjusted so that the total thereof is 100% including inevitable impurities.

3. The brazing alloy for bonding in air according to claim 1, wherein at least one kind selected from the group consisting of Si, Ca, Ti, Zr, nitrides thereof, carbides thereof, and hydrides thereof, is further added, the total of the amounts of B and the added component is set to be greater than 8 vol. % and not more than 50 vol. %, and the amounts of Ag, B, and the added component are adjusted so that the total thereof is 100% including inevitable impurities.

4. The brazing alloy for bonding in air according to claim 1, wherein the brazing alloy has a melting point of not less than 650° C. and not more than 850° C. in air.

5. A bonded article formed of a set of a metal member and a metal member, a set of a ceramic member and a ceramic member, or a set of a metal member and a ceramic member, which are bonded with the brazing alloy recited in claim 1, and the bonded article having gas sealing characteristics.

6. The bonded article according to claim 5, wherein the bonded article is used for a fuel cell or a solid oxide fuel cell.

7. A current collecting material formed of a set of a metal member and a metal member, a set of a ceramic member and a ceramic member, or a set of a metal member and a ceramic member, which are bonded with the brazing alloy recited in claim 1, and the current collecting material having electrical conductivity.

8. The current collecting material according to claim 7, wherein the current collecting material is used for a fuel cell or a solid oxide fuel cell.

9. The brazing alloy for bonding in air according to claim 2, wherein the brazing alloy has a melting point of not less than 650° C. and not more than 850° C. in air.

10. The brazing alloy for bonding in air according to claim 3, wherein the brazing alloy has a melting point of not less than 650° C. and not more than 850° C. in air.

11. A bonded article formed of a set of a metal member and a metal member, a set of a ceramic member and a ceramic member, or a set of a metal member and a ceramic member, which are bonded with the brazing alloy recited in claim 2, and the bonded article having gas sealing characteristics.

12. A bonded article formed of a set of a metal member and a metal member, a set of a ceramic member and a ceramic member, or a set of a metal member and a ceramic member, which are bonded with the brazing alloy recited in claim 3, and the bonded article having gas sealing characteristics.

13. A current collecting material formed of a set of a metal member and a metal member, a set of a ceramic member and a ceramic member, or a set of a metal member and a ceramic member, which are bonded with the brazing alloy recited in claim 2, and the current collecting material having electric conductivity.

14. A current collecting material formed of a set of a metal member and a metal member, a set of a ceramic member and a ceramic member, or a set of a metal member and a ceramic member, which are bonded with the brazing alloy recited in claim 3, and the current collecting material having electric conductivity.
